(19) United States
(12) Patent Application Publication
(10) Pub. No.: US 2026/0333492 A1
(43) Pub. Date: Oct. 22, 2026

(54) METHODS FOR RLF AND RE-ESTABLISHMENT IMPROVEMENT IN NTN

(71) Applicant: INTERDIGITAL PATENT HOLDINGS, INC., Wilmington, DE (US)

(72) Inventors: Brian MARTIN, Farnham (GB); Dylan WATTS, Montreal (CA); Oumer TEYEB, Montreal (CA)

(73) Assignee: INTERDIGITAL PATENT HOLDINGS, INC., Wilmington, DE (US)

(21) Appl. No.: 19/113,348

(22) PCT Filed: Sep. 28, 2023
(86) PCT No.: PCT/US2023/033982

§ 371 Date: Mar. 19, 2025

Related U.S. Application Data
(60) Provisional application No. 63/410,765, filed on Sep. 28, 2022.
(60) Provisional application No. 63/421,386, filed on Nov. 1, 2022.

(51) Int. Cl. H04W 76/19; H04B 17/318; H04L 43/0811; H04W 36/00

(52) U.S. Cl. CPC H04W 76/19; H04B 17/328; H04L 43/0811; H04W 36/0088

(57) ABSTRACT

A wireless transmit/receive unit (WTRU) may be configured to receive configuration information, that may comprise an indication of a stop time of a first cell and a start time of a second cell. The WTRU may be configured to perform radio link monitoring (RLM) measurements on the first cell. The WTRU may be configured to determine that the first cell has stopped based on the received indication of a stop time of the first cell. The WTRU may be configured to stop the RLM measurements on the first cell. The WTRU may be configured to initiate a radio resource control (RRC) connection re-establishment procedure on the second cell in response to the determination that the first cell has stopped. The first cell may be a current cell and the second cell may be a neighbor cell or target cell. The configuration information may further comprise a time offset value.

### CROSS-REFERENCE TO RELATED APPLICATIONS

This application claims the benefit of U.S. Provisional Application No. 63/410,765, filed Sep. 28, 2022 and U.S. Provisional Application No. 63/421,386, filed Nov. 1, 2022, the contents of which are incorporated herein by reference.

### BACKGROUND

Non-terrestrial networks (NTN) facilitate deployment of wireless networks in areas where land-based antennas are impractical due to, for example, geography or cost. It is envisioned that, coupled with terrestrial networks, NTN will enable truly ubiquitous coverage of 5G networks. Initial NTN deployments support basic talk and text anywhere in the world, however, it is expected that further updates coupled with proliferation of next-generation low-orbit satellites will enable enhanced services such as web browsing.

### SUMMARY

A wireless transmit/receive unit (WTRU) may be configured to receive configuration information. The configuration information may comprise an indication of a stop time of a first cell and a start time of a second cell. The WTRU may be configured to perform radio link monitoring (RLM) measurements on the first cell. The WTRU may be configured to determine that the first cell has stopped based on the received indication of a stop time of the first cell. The WTRU may be configured to stop the RLM measurements on the first cell. The WTRU may be configured to initiate a radio resource control (RRC) connection re-establishment procedure on the second cell in response to the determination that the first cell has stopped. The first cell may be a current cell and the second cell may be a neighbor cell or target cell. The configuration information may further comprise a time offset value. The time offset value may be related to the stop time of the first cell. The WTRU may be configured to perform measurements on the second cell before the first cell stops and on a condition that the second cell has started. The measurements may be performed on the second cell when the first cell stop time is within a received time offset value of stopping. The WTRU may be configured to delay initiating the connection re-establishment procedure on the second cell on a condition that the first cell stops before the second cell starts and until the second cell starts. The measurements may be performed on the second cell before an occurrence of a radio link failure (RLF) or upon an occurrence of a RLF. The WTRU may be configured to perform RRC connection re-establishment based on the stop time of the first cell and the start time of the second cell. RRC connection re-establishment may be performed without using a T310 timer expiration. The WTRU may be configured to trigger a radio link failure (RLF) or an RRC connection re-establishment on a condition that a cell quality level criteria is met. The cell quality level criteria may comprise at least one of: a measured signal quality of the second cell is above an RSRP or RSRQ threshold and a measured signal quality of the first cell is below an RSRP or RSRQ threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of interfaces in a NTN;

FIG. 3 shows an example radio link failure (RLF) and re-establishment procedure;

FIG. 4 shows an example of an enhanced RLF procedure;

FIG. 5 shows an example of RLF enhancement for an overlapping coverage scenario;

FIG. 6 shows an example method of RLF enhancement for an overlapping coverage scenario;

FIG. 7 shows an example of RLF enhancement for a discrete change of coverage scenario;

FIG. 8 shows an example method of RLF enhancement for an discrete change of coverage scenario;

FIG. 9 shows an example of RLF enhancement for a discontinuous coverage scenario;

FIG. 10 shows an example method of RLF enhancement for a discontinuous coverage scenario;

FIG. 11 shows an example method for RLF enhancement; and

FIG. 12 shows an example method of RLF/re-establishment.

### DETAILED DESCRIPTION

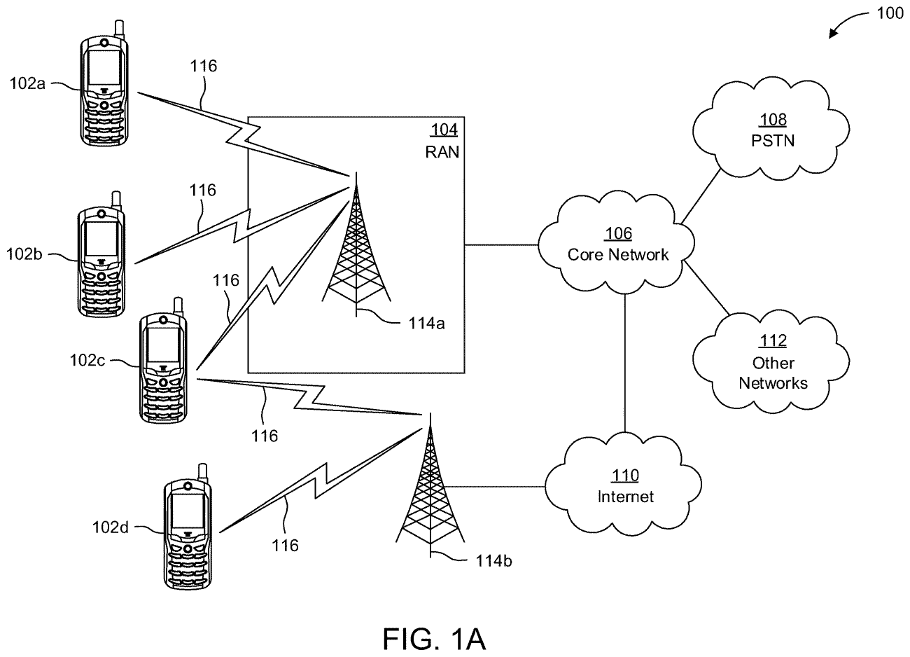

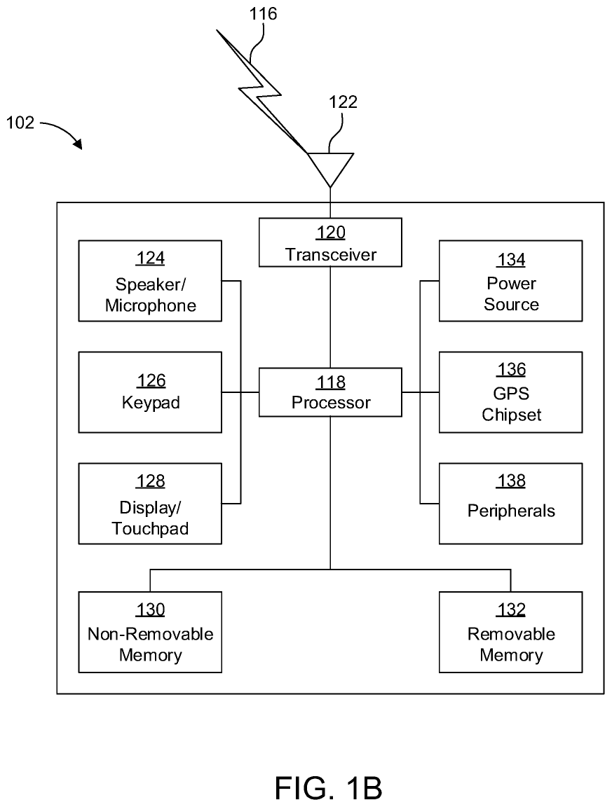

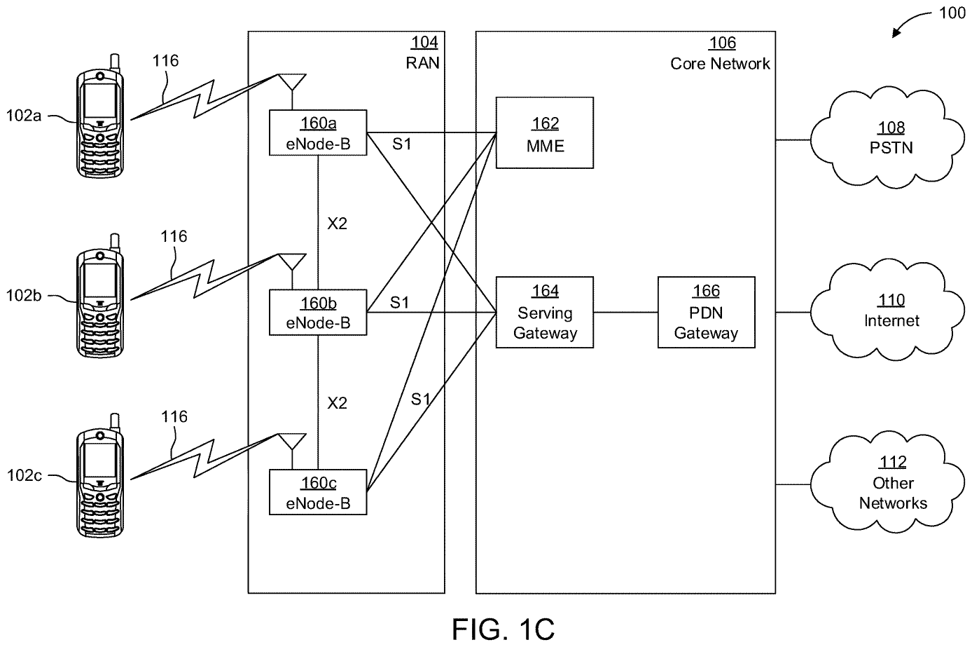

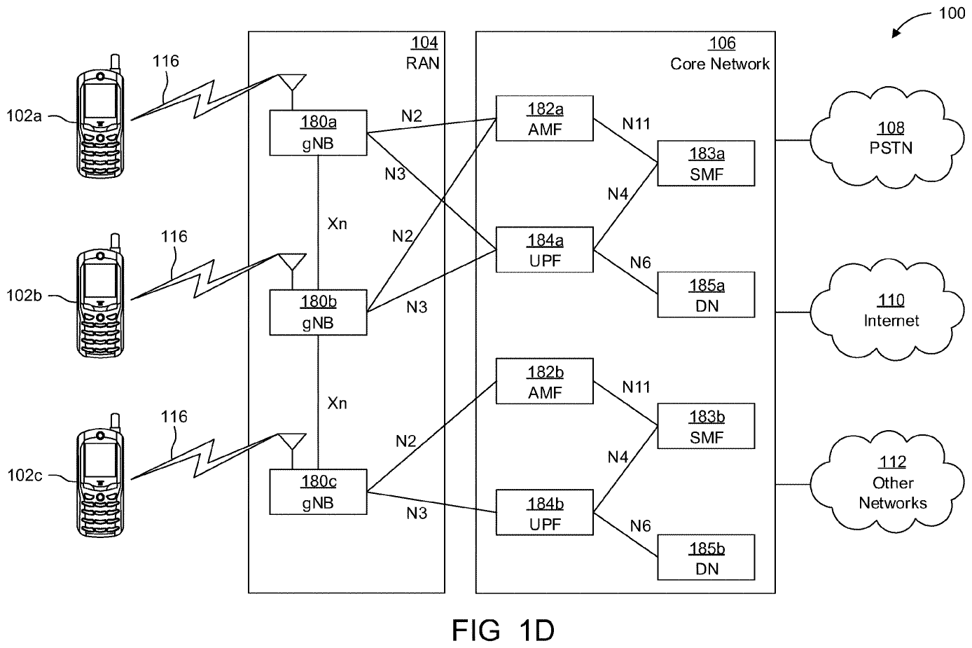

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A basic NTN comprises an aerial or space-borne platform which, via a gateway (GW), transports signals from a land-based gNB to a WTRU and vice-versa. Current NR NTN supports power class 3 WTRU with an omnidirectional antenna and linear polarization, or a very small aperture antenna (VSAT) terminal with directive antenna and circular polarization. Support for LTE-based narrow-band IoT (NB-IoT) and eMTC type devices have been standardized. Regardless of device type, it is assumed that all current NTN WTRUs are global navigation satellite systems (GNSS) capable.

Aerial or space-borne platforms are classified in terms of orbit, with current standardization focusing on low-earth orbit (LEO) satellites with an altitude range of 300-1500 km and geostationary earth orbit (GEO) satellites with an altitude at 35,786 km. Other platform classifications such as medium-earth orbit (MEO) satellites with an altitude range 7000-25000 km and high-altitude platform stations (HAPS) with an altitude of 8-50 km are assumed to be implicitly supported. Satellite platforms are further classified as having a “transparent” or “regenerative” payload. Transparent satellite payloads implement frequency conversion and RF amplification in both uplink and downlink, with multiple transparent satellites possibly connected to one land-based gNB. Regenerative satellite payloads can implement either a full gNB or gNB distributed unit (DU) onboard the satellite. Regenerative payloads may perform digital processing on the signal including demodulation, decoding, re-encoding, re-modulation and/or filtering.

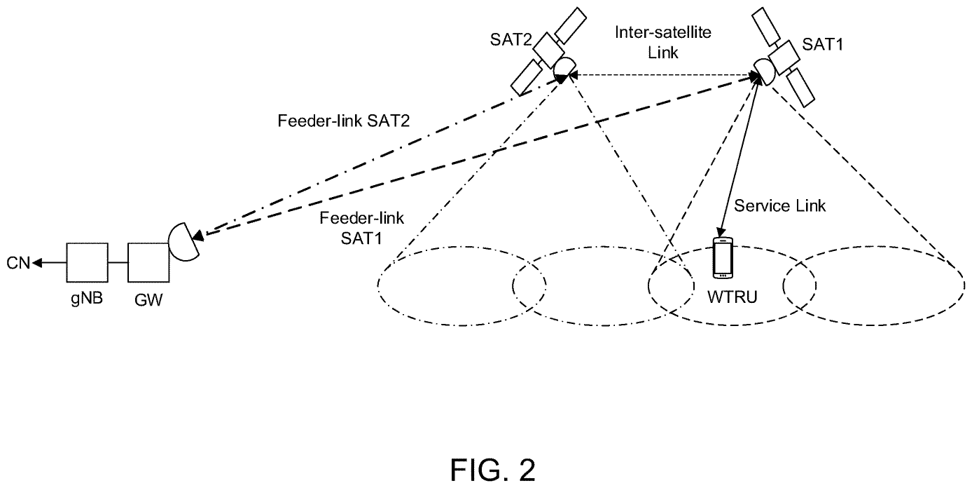

FIG. 2 shows radio interfaces for a NTN. The NTN may comprise a core network (CN), gNB, a gateway (GW), satellites (e.g. SAT 1 and SAT2), and a WTRU. The NTN may comprise a feeder-link, which may be a wireless link between the GW and a satellite (e.g. Feeder-link SAT1 and Feeder-link SAT2). The NTN may comprise a service link, which may be a radio link between a satellite and a WTRU. The NTN may comprise an inter-satellite link (ISL), which may be a transport link between satellites. The ISL is supported only by regenerative payloads and may be a 3GPP radio or proprietary optical interface.

Depending on the satellite payload configuration, different 3GPP radio interfaces may be used for each radio link. In a transparent payload, a NR-Uu radio interface may be used for both the service link and feeder-link. For a regenerative payload, the NR-Uu interface may be used on the service link, and a satellite radio interface (SRI) may be used for the feeder-link. A detailed user plane/control plane (UP/CP) protocol stack for each payload configuration may be found in 3GPP TR 38.821 Section 5.1 and 5.2.

An NTN satellite may support multiple cells. Each cell may comprise of one or more satellite beams. Satellite beams cover a footprint on earth, like a terrestrial cell, and may range in diameter from 100-1000 km in LEO deployments, and 200-3500 km diameter in GEO deployments. Beam footprints in GEO deployments remain fixed relative to earth, and in LEO deployments the area covered by a beam/cell changes over time due to satellite movement. This beam movement may be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, a round-trip time (RTT) and maximum differential delay may be significantly larger than that of terrestrial systems. In a typical transparent NTN deployment, RTT may range from 25.77 ms (LEO @ 600 km altitude) to 541.46 ms (GEO) and maximum differential delay may range from 3.12 ms to 10.3 ms. The RTT of a regenerative payload may be approximately half that of a transparent payload, as a transparent configuration comprises both the service and feeder links, whereas the RTT of a regenerative payload considers the service link only. To minimize impact to existing NR systems (e.g. to avoid preamble ambiguity or properly time reception windows), prior to initial access a WTRU may perform timing pre-compensation.

The timing pre-compensation procedure may require a WTRU to obtain its position via GNSS, and the feeder-link (or common) delay and satellite position via satellite ephemeris data. The satellite ephemeris data is periodically broadcast in system information, and comprises the satellite speed, direction, and velocity. The WTRU may then estimate the distance, and thus delay, from the satellite, and then add the feeder-link delay component to obtain the full WTRU-gNB RTT, which may then be used to offset timers, reception windows, or timing relations. It is assumed that frequency compensation is performed by the network.

Other key enhancements in NTN concern WTRU mobility and measurement reporting. The difference in RSRP between cell center and cell edge is not as pronounced as in terrestrial systems. This, coupled with the much larger region of cell overlap results in traditional measurement-based mobility to become less reliable in an NTN environment. New conditional handover and measurement reporting triggers are introduced relying on location and time, with details to be confirmed. Enhanced mobility is of special interest in LEO deployments where, due to satellite movement, even a stationary WTRU is expected to perform mobility approximately every 7 seconds, depending on deployment characteristics.

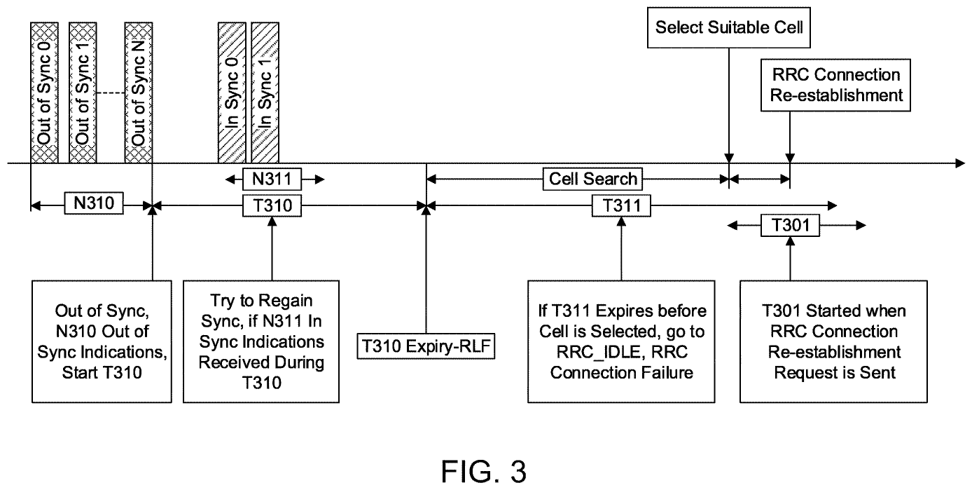

A radio link failure (RLF) and re-establishment procedure is summarized in FIG. 3. While in a RRC_CONNECTED state, a WTRU may perform radio link monitoring (RLM) on the serving cell. The WTRU may be configured with timers and counters to use when evaluating RLF and performing radio link recovery or re-establishment. Upon detection of N310 consecutive “out of sync” indications at RRC from L1 (RLM) a timer may be started with a length or duration T310. While T310 is running the WTRU may attempt to recover the radio link on the serving cell. If N311 consecutive “in sync” indicators are received at RRC from L1, then the WTRU may consider the radio link to be recovered and may resume normal operation and continue RLM on the serving cell. If T310 expires then the WTRU may consider this as a RLF. Upon detection of a RLF, a timer may be started with a length or duration T311, and the WTRU may perform a cell search in order to determine whether there is a suitable cell available on which the WTRU may perform an RRC connection re-establishment. If the timer T311 expires before the WTRU finds a suitable cell, then the WTRU may enter RRC_IDLE mode with a cause “RRC Connection failure”. If the WTRU does find a suitable cell, which may include the original cell, then this cell may be selected, T311 may be stopped, T301 may started, and an RRC Connection re-establishment procedure may be started. If the timer T301 expires before the RRC Connection re-establishment is complete then the WTRU may enter idle mode with a cause “RRC Connection failure”.

A RLF may occur, for example, when the WTRU goes out of coverage (e.g. entering a tunnel or moving to a rural area out of cellular coverage). A RLF may occur, for example, as a result of a too late handover, whereby RLF is detected on the serving cell before a handover may be completed. The first part of the procedure (N310, T310, N311) in FIG. 3 is intended to allow the WTRU a chance to recover the radio link in case of a temporary problem. The second part of the procedure after T310 expiration is intended to allow the WTRU to attempt to re-establish the connection on the same or another cell without having to release the connection completely.

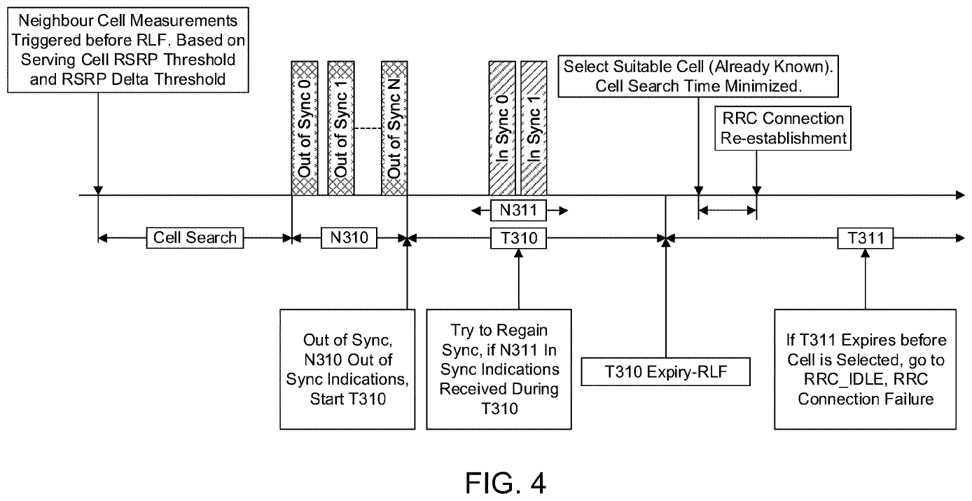

NB-IoT relies on RLF and re-establishment to perform mobility in RRC_CONNECTED because no measurement reporting or handover is supported. The reason for this is that when NB-IoT was initially standardized, it was targeted at use-cases for stationary devices such as power meters. However, mobile devices soon came onto the market (e.g. bicycle hire using NB-IoT for communication). Once RLF is detected (e.g. after T310 expires) the WTRU may perform cell search, and then perform re-establishment to a suitable cell. For moving devices, use of the existing RLF procedure was determined to be inefficient since no measurements are performed on neighbor cells before RLF occurs. The delay caused by the WTRU having to perform a cell search in order to detect a suitable cell causes significant interruption during which the WTRU is both unreachable (e.g. by paging) and unable to communicate (e.g. transmit uplink reports). In order to reduce the interruption, the RLF procedure was enhanced for NB-IoT. The enhancements are summarized in FIG. 4.

To reduce a cell detection time, and hence reduce the overall re-establishment time when an RLF occurs, neighbor cell measurements in RRC_CONNECTED before RLF were introduced. If measurements are performed before an RLF occurs, then a target cell may be known and re-establishment may be performed more quickly during T311 (i.e. no cell search needed).

The neighbor cell measurements may be triggered when the serving cell measured RSRP goes below a configured threshold, and the delta RSRP-> if RSRP change is greater than delta threshold within a configured time period. This is defined in 3GPP TS 36.331 clause 5.5.8 (Measurements in NB-IoT) as follows:

Upon transition to RRC_CONNECTED mode, the UE shall:
1> if neighCellMeasCriteria is present in SystemInformationBlockType3-NB:
   2> set NRSRP_{Ref} to the latest result of the serving cell measurement as used for cell selection/reselection evaluation;
   2> if the relaxed monitoring criterion defined in TS 36.304 [4] was not fulfilled:
      3> start T326 with the value t-MeasureDeltaP;

While in RRC_CONNECTED mode, after performing a measurement, the UE shall:
1> in the following use the NRSRP measurement for the measured carrier and nrs-PowerOffsetNonAnchor corresponding to the measured carrier;
1> if neighCellMeasCriteria is present in SystemInformationBlockType 3-NB:
   2> if (NRSRP_{Ref}−(NRSRP−PowerOffsetNonAnchor))>s-MeasureDeltaP:
      3> set NRSRP_{Ref}=(NRSRP−nrs-PowerOffsetNonAnchor);
      3> start or restart T326 with the value t-MeasureDeltaP;
1> if neighCellMeasCriteria is not present in SystemInformationBlockType3-NB; or
1> if T326 is running:
   2> if (NRSRP−nrs-PowerOffsetNonAnchor)<s-MeasureIntra, perform intra-frequency measurements as defined in TS 36.133 [16];
   2> if (NRSRP−nrs-PowerOffsetNonAnchor)<s-MeasureInter, perform inter-frequency measurements as defined in TS 36.133 [16].

In IoT-NTN it is proposed to introduce the procedure described above. However, NTN deployments are not the same as terrestrial networks (TN). There are several scenarios to consider. A target cell coverage may overlap with source cell coverage, similar to TN, (e.g. GEO) (overlapping coverage scenario). Cell A may switch to cell B at a given time (e.g. earth-fixed scenario) (discrete change scenario). Cell A may disappear before cell B appears (discontinuous coverage scenario). RSRP based triggers may be less effective in NTN cells due to a more uniform RSRP measurement across the cell, as compared to terrestrial networks. It may be known with more certainty in NTN whether a cell change has occurred or whether there is a temporary radio link problem Time based information may be considered including a current cell stop time and a target cell start time and location based information (WTRU may estimate cell change time).

A time based trigger may be used to start the measurements. A distance based trigger may be used to start the measurements. However, if this is based on the serving cell alone then this may not sufficient to ensure a WTRU can measure the target cell at the correct or optimal time or to trigger RLF at the correct or optimal time in all of the scenarios.

A measurement trigger may be based on both a current cell service time and a next cell service time. The trigger for neighbor cell measurements may be based on the time the serving cell is going to stop (e.g. based on a parameter t-service), and the target cell start time (e.g. based on a parameter t-serviceStart). Measurements may be started (e.g. only started) when the target cell is available (i.e. WTRU takes into account both the source and target cell coverage times). Measurements may occur before RLF (e.g. a configurable time offset before cell 1 stops) in case cell 1 stop time is later than cell 2 start time (scenario 1: overlapping coverage). Measurements may occur upon RLF in case cell 1 stop time is equal to cell 2 start time (scenario 2: discrete change). Measurements may occur a time after RLF if cell 1 stops before cell 2 starts (scenario: 3 discontinuous coverage).

A re-establishment trigger may be based on both a current cell service time and a next cell service time. The current cell stop time (e.g. based on a parameter t-service) combined with the future cell start time (e.g. based on a parameter t-serviceStart) may be used as a trigger for performing RRC Connection re-establishment, instead of using T310 expiration/RLF for triggering RRC connection re-establishment. Out of sync counting and T310 may be reduced or removed, in case cell 1 stops, however out of sync counting and T310 may be performed when cell 1 has not stopped (for legacy RLF recovery). T311 may be started when both the current cell stops and the next cell starts.

While it makes sense to start measurements, if possible, on future cells a short time before the WTRU loses coverage of the current cell in order that the WTRU may change cells more quickly when the coverage is lost (similar to the use of an RSRP threshold in NB-IoT indicating the WTRU is reaching the cell edge), in NTN networks in order to ensure the WTRU does not attempt to measure a future cell before it is available (hence wasting measurement effort and consuming power unnecessarily) the WTRU should also take into account the start time of the incoming cell. By considering both the stop time of the current cell and the start time of the incoming/future cell, a single solution may address the various scenarios in NTN. The current cell stop time may be provided using, for example, a parameter “t-service”. The current cell stop time may be provided by the serving cell. The current cell stop time may be provided in system information (e.g. system information block (SIB)) and/or radio resource control (RRC) signaling. The next cell start time may be provided using, for example, a parameter “t-serviceStart”. The next cell start time may be provided by the serving cell. The next cell start time may be provided in system information (e.g. system information block (SIB)) and/or radio resource control (RRC) signaling.

The current RLF procedure, in LTE and NR, is designed to provide sufficient time for a WTRU to recover the radio link on a current cell in case of temporary radio link problems. For TN, it is difficult for the WTRU to determine whether out-of-sync is due to temporary radio link problems or a change of cell or coverage situation. For NTN, we can take advantage of the stop time of the current cell and the start time of neighbor cells (e.g. using the parameter “t-Service” provided in system information) to determine whether out of sync is due to a cell change or potential radio condition problems. As such, rather than use the existing procedures (e.g. to count N310 out of synch indication then wait for T310 to expire before declaring RLF), we can use the time information (e.g. current cell stop time and/or next cell start time) to reduce or completely eliminate N310 and T310 and trigger RLF directly based on the time information. The term “trigger RLF” may refer to triggering the procedures related to RLF, which is to perform for example cell search and RRC re-establishment. This may be done without considering a failed radio link in the traditional sense, for example instead of “trigger RLF”, “trigger RRC Re-establishment” or “trigger cell search” may be used.

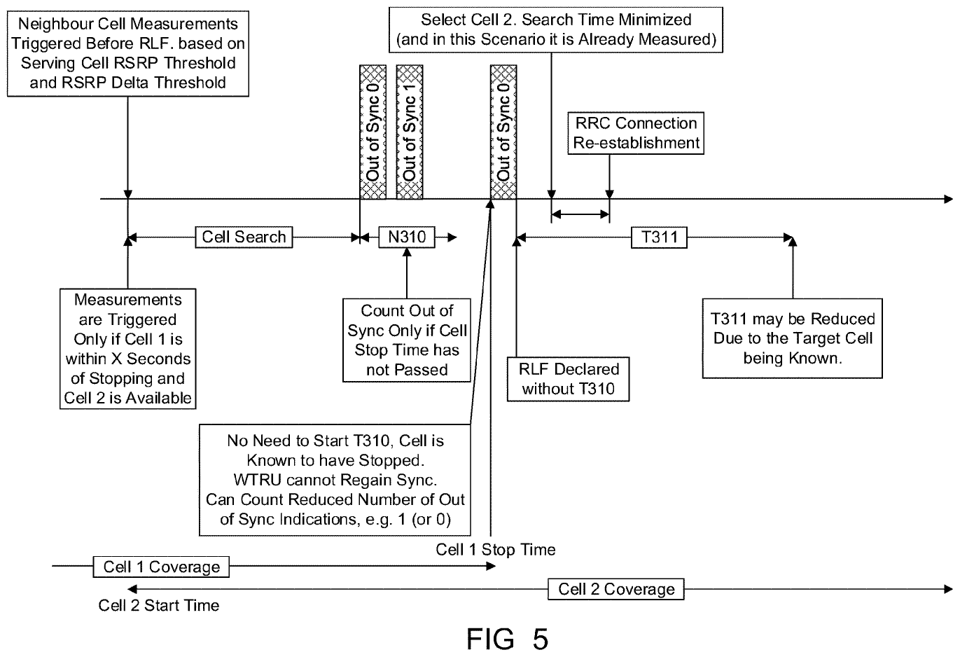

FIG. 5 shows an example of RLF enhancement in an overlapping coverage scenario. The WTRU may start on a first cell (e.g. cell 1) and move to a second cell (e.g. cell 2). In this example, there is a period of time where the WTRU is in coverage of both cell 1 and cell 2, similar to what would be expected in a TN. The WTRU may receive time information relating to when cell 1 stops and when cell 2 starts. The WTRU may receive a time offset (e.g. X seconds) relating to the stop time of cell 1. Before this time offset time of the stop time of cell 1, the WTRU is not required to perform measurements of cell 2. The WTRU may receive one or more radio quality thresholds, for example an RSRP threshold and an RSRP delta threshold.

Since cell 2 coverage begins before cell 1 coverage ends, the WTRU may perform measurements of cell 2 when the time is within the time offset (e.g. X seconds) of cell 1 stop time. The measurements may be triggered before the RLF occurs due to cell 1 coverage stopping, but the trigger for measurements may include the stop time of the current cell (i.e. cell 1) and start time of the next cell (i.e. cell 2). In this case the WTRU may perform measurements after cell 2 appears and before cell 1 stops which may ensure that cell 2 has been detected and measured and hence may speed up or eliminate cell search time after RLF.

In addition to the measurement trigger, the re-establishment may also be triggered using the cell coverage time information. Until cell 1 stops, the WTRU may continue to perform RLM, out-of-sync indication counting and use a T310 timer for attempting to recover the radio link on cell 1 if an out-of-sync condition is detected. If it is known that cell 1 has stopped, or if it is known that cell 1 will stop before T310 expires, then there may be no need to count out-of-sync indications or start T310 to attempt to recover the radio link on cell 1. Rather, the WTRU may trigger RLF on cell 1 (or re-establishment to cell 2) immediately based on the cell 1 stop time and without using T310, or based on detection of a single, or reduced number of out-of-sync indications. The WTRU may take into account the start time of cell 2 in triggering re-establishment. This is mainly for other scenarios as in this scenario cell 2 has already started so RLF/re-establishment may be immediately triggered when cell 1 stops.

When the re-establishment procedure is triggered the WTRU may utilize a separate or scaled T311, which may be shorter than the T311 used for re-establishment due to RLF triggered in the conventional way, since much of the time that T311 allows for is not needed because the target cell is already known, detected, and measured.

In the scenario in FIG. 5, measurements may be triggered when cell 2 is available and the WTRU is within a time offset (e.g. X seconds) of cell 1 stop time. The RLF/re-establishment may be triggered directly upon cell 1 stop without using T310.

In an example, the WTRU may trigger RLF/re-establishment before the stop time of cell 1. For example, the RLF/re-establishment may be triggered immediately at the expected start time of cell 2. Alternatively the WTRU may start measurements immediately at the expected start time of cell 2 and trigger RLF/re-establishment when cell 2 is detected and/or when a cell quality level criteria is met. The cell quality level criteria may be, for example, that the measured signal quality of cell 2 is above an RSRP and/or RSRQ threshold, and/or the measured signal quality of cell 1 is below an RSRP and/or RSRQ threshold.

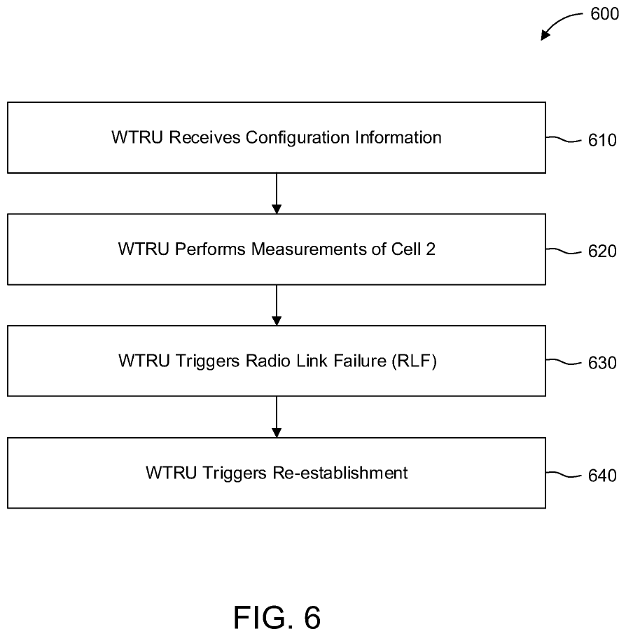

FIG. 6 shows an example method 600 of RLF enhancement in an overlapping coverage scenario. The WTRU may be in current coverage of a first cell (e.g. cell 1) and may move into coverage of a second cell (e.g. cell 2). There may be a period of time where the WTRU is in overlapping coverage of both cell 1 and cell 2.

The WTRU may receive configuration information 610. The configuration information may indicate time information indicating when cell 1 stops and when cell 2 starts. The configuration information may indicate a time offset value (e.g. X seconds) relating to the stop time of cell 1. The configuration information may indicate one or more radio quality thresholds, for example an RSRP threshold and an RSRP delta threshold. The configuration information may be received in one message or a plurality of messages. The configuration information may be provided, for example, in system information or may be provided in RRC dedicated signaling. The configuration information may include location information of the current and neighboring satellites which the WTRU may use to estimate the current cell stop time and next cell start time, rather than an explicit time indication.

The WTRU may perform measurements of cell 2 620. The WTRU may perform the measurement upon a triggering condition. The triggering condition may be before RLF. The measurements may be triggered based on the serving cell RSRP threshold and/or RSRP delta threshold. For example, if the serving cell RSRP is above or below the RSRP threshold, then a measurement may be triggered. The measurements may be triggered based on the stop time of cell 1 and the start time of cell 2. The measurements may be triggered on a condition that cell 1 is within the time offset (e.g. X seconds) of stopping and cell 2 is available or within the WTRU coverage. The measurement may be triggered based on the RSRP threshold and cell 1 is within the time offset of stopping and cell 2 is available. In this case the WTRU may perform measurements after cell 2 appears and before cell 1 stops which may ensure that cell 2 has been detected and measured and hence may speed up or eliminate cell search time after RLF.

Until cell 1 stops, the WTRU may continue to perform RLM, out-of-sync indication counting and use a T310 timer for attempting to recover the radio link on cell 1 if an out-of-sync condition is detected. If it is known that cell 1 has stopped, or if it is known that cell 1 will stop before T310 expires, then there may be no need to count out-of-sync indications or start T310 to attempt to recover the radio link on cell 1 The WTRU may trigger or declare radio link failure (RLF) 630. The WTRU may trigger or declare RLF on cell 1 (or re-establishment to cell 2) immediately based on the cell 1 stop time and without using T310. There may be no need to start T310 since cell 1 is known to have stopped and the WTRU cannot regain synchronization to cell 1. The WTRU may trigger RLF on cell 1 (or re-establishment to cell 2) based on detection of a single, or reduced number of out-of-sync indications. The WTRU may trigger RLF before the stop time of cell 1. For example, the RLF may be triggered immediately at the expected start time of cell 2. The WTRU may start measurements immediately at the expected start time of cell 2 and trigger RLF when cell 2 is detected and/or when a cell quality level criteria is met. The cell quality level criteria may be, for example, that the measured signal quality of cell 2 is above an RSRP and/or RSRQ threshold, and/or the measured signal quality of cell 1 is below an RSRP and/or RSRQ threshold. The WTRU may start a T311 timer upon RLF.

The WTRU may trigger and/or perform a re-establishment procedure 640. The re-establishment procedure may be triggered using the cell coverage time information. The WTRU may take into account the start time of cell 2 in triggering re-establishment. Since cell 2 has already started RLF/re-establishment may be immediately triggered when cell 1 stops. The re-establishment may be triggered without using T310. The WTRU may trigger re-establishment before the stop time of cell 1. For example, the re-establishment may be triggered immediately at the expected start time of cell 2. The WTRU may start measurements immediately at the expected start time of cell 2 and trigger re-establishment when cell 2 is detected and/or when a cell quality level criteria is met. The cell quality level criteria may be, for example, that the measured signal quality of cell 2 is above an RSRP and/or RSRQ threshold, and/or the measured signal quality of cell 1 is below an RSRP and/or RSRQ threshold.

When the re-establishment procedure is triggered the WTRU may utilize a separate or scaled T311 timer, which may be shorter than the T311 used for re-establishment due to RLF triggered in the conventional way, since much of the time that T311 allows for is not needed because the target cell (i.e. cell 2) is already known, detected, and measured.

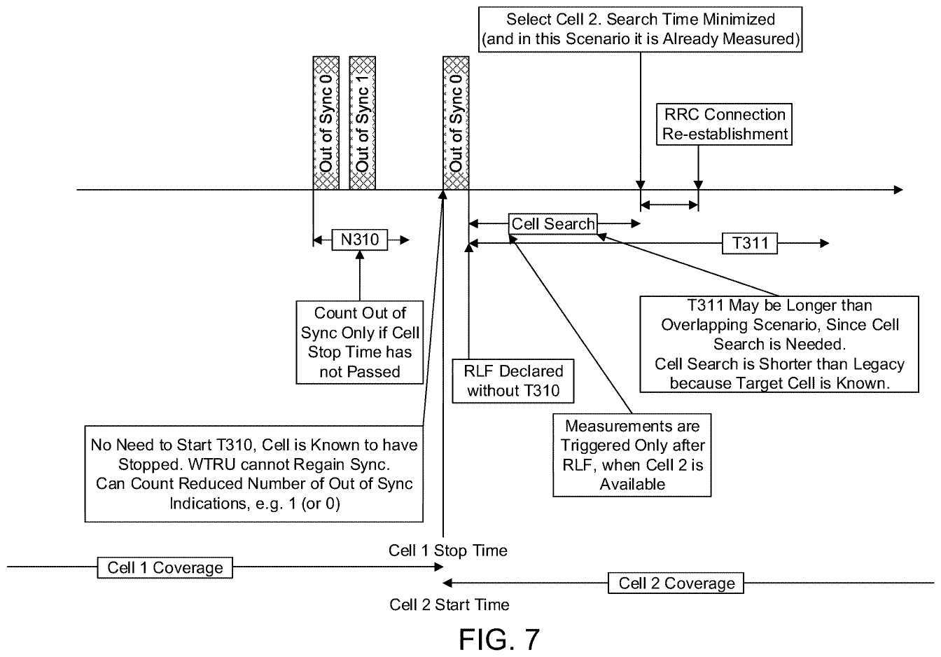

FIG. 7 shows an example of RLF enhancement in a discrete change of coverage scenario. In FIG. 7, similar to FIG. 5, the WTRU starts on cell 1 and moves to cell 2. In this example, however, there is a discrete time when the current/serving cell (e.g. cell 1) stops and the incoming/target cell (e.g. cell 2) starts. This may be the case, for example, in certain earth-fixed cell scenarios whereby the satellite beams a cell to a fixed geographic area and as one satellite moves away and incoming satellite starts to provide coverage to that geographical area.

In FIG. 7, for measurements, similar to FIG. 5, the WTRU may take into account both the stop time of cell 1 and the start time of cell 2. In this scenario the main trigger for measurements is the start time of cell 2. The measurements are not triggered ahead of the RLF because cell 2 is not available ahead of the RLF. The measurements of the target cell begin at the cell 1 stop time/cell 2 start time. Similar to the example in FIG. 5, in this example the WTRU may use the cell 1 stop time to optimize or speed up the re-establishment procedure, even if measurements are not already available, because the WTRU may immediately trigger RLF/re-establishment without using N310 and T310. In this scenario, T311 may be reduced compared to the value used for regular RLF, however since the time includes performing measurements on the incoming cell 2, the time may be longer than that used in the scenario in FIG. 5 to take this into account.

In the scenario in FIG. 7, RLF/re-establishment and target cell measurements are triggered at the time when both cell 1 stops and cell 2 starts.

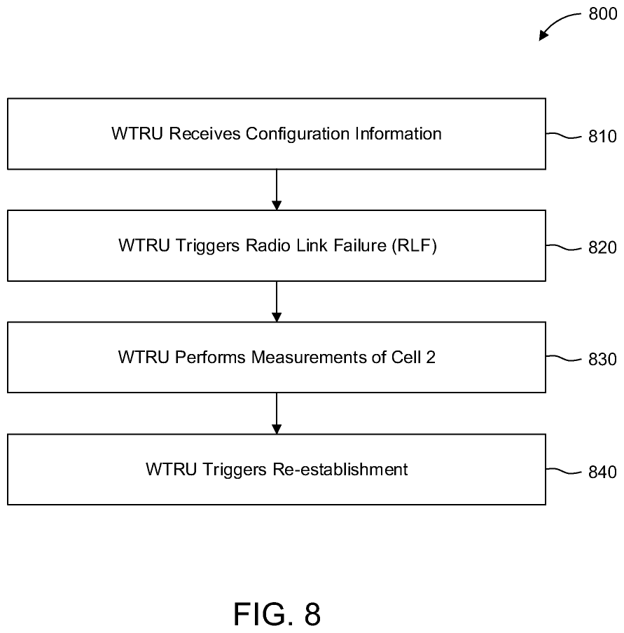

FIG. 8 shows an example method 800 of RLF enhancement in discrete change of coverage scenario. The WTRU may be in current coverage of a first cell (e.g. cell 1) and may move into coverage of a second cell (e.g. cell 2). There may be a period of time where the WTRU is in overlapping coverage of both cell 1 and cell 2. There may be a discrete time when cell 1 stops and cell 2 starts.

The WTRU may receive configuration information 810. The configuration information may indicate time information indicating when cell 1 stops and when cell 2 starts. The configuration information may indicate one or more radio quality thresholds, for example an RSRP threshold and an RSRP delta threshold. The configuration information may be received in one message or a plurality of messages. The configuration information may be provided, for example, in system information or may be provided in RRC dedicated signaling. The configuration information may include location information of the current and neighboring satellites which the WTRU may use to estimate the current cell stop time and next cell start time, rather than an explicit time indication.

The WTRU may trigger or declare RLF 820. The WTRU may trigger or declare RLF at the time when both cell 1 stops and cell 2 starts. The WTRU may trigger or declare RLF based on detection of a single, or reduced number of out-of-sync indications after the time when both cell 1 stops and cell 2 starts. The WTRU may start a T311 timer upon RLF.

The WTRU may perform measurements on cell 2 830. The measurements may be triggered based on the stop time of cell 1 and the start time of cell 2. In this scenario the main trigger for measurements is the start time of cell 2. The measurements are not triggered ahead of the RLF because cell 2 is not available ahead of the RLF.

The WTRU may trigger and/or perform a re-establishment procedure 840. Similar to the example in FIG. 5, in this example the WTRU may use the cell 1 stop time to optimize or speed up the re-establishment procedure, even if measurements are not already available, because the WTRU may immediately trigger RLF/re-establishment without using N310 and T310. In this example, T311 may be reduced compared to the value used for regular RLF, however since the time includes performing measurements on the incoming cell 2, the time may be longer than that used in the scenario in FIG. 5 to take this into account. The re-establishment procedure may be triggered at the time when both cell 1 stops and cell 2 starts.

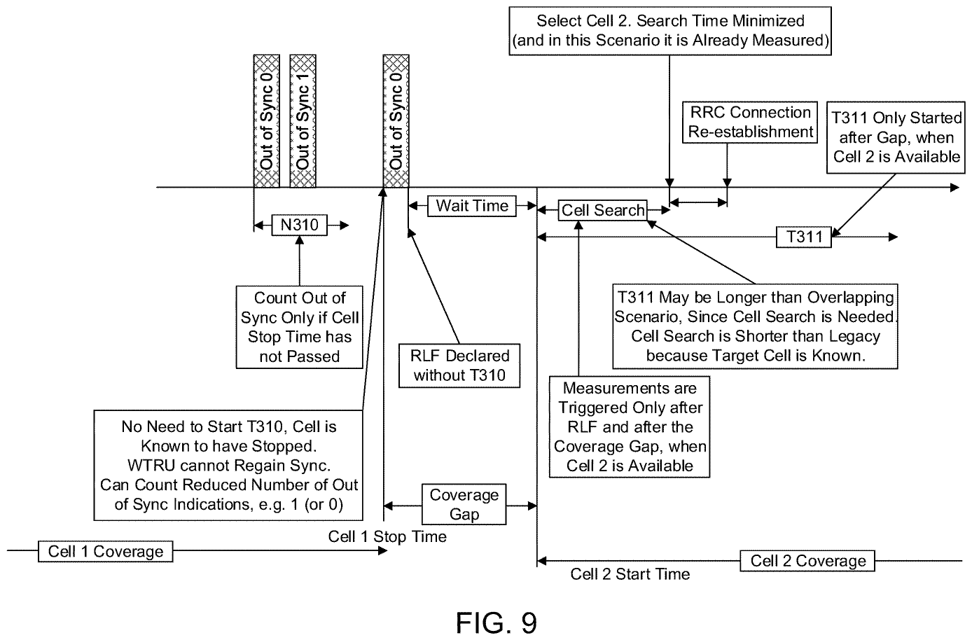

FIG. 9 shows an example of RLF enhancement in a discontinuous coverage scenario. In FIG. 9, similar to FIG. 5 and FIG. 7, the WTRU starts on cell 1 and moves to cell 2. In this example, there is a coverage gap (i.e. time gap) between cell 1 stopping and cell 2 starting.

In FIG. 9, similar to the example in FIG. 7, the measurements may not be started before RLF/re-establishment because cell 2 is not yet available. In this example, the WTRU may wait for the duration of the coverage gap before performing measurements (i.e. the WTRU waits until cell 2 becomes available).

Similar to the examples in FIGS. 5 and 7, the WTRU may immediately trigger or declare RLF when cell 1 stops, however in this example an additional wait time is used before proceeding to a measurement and re-establishment procedure. The wait time may be implemented either after RLF is detected/triggered due to cell 1 stop and before T311/measurements/re-establishment starts or it may be implemented before triggering RLF/re-establishment. Either way, the WTRU does not need to perform out-of-sync counting (N310) or attempt to regain synchronization to cell 1 during T310. The RLF/re-establishment procedure trigger is therefore based on cell 1 stop and cell 2 start time.

In the example of FIG. 9, similar to the example in FIG. 7 the T311 may be shorter than that used for regular RLF re-establishment, but longer than the value that may be used in the example in FIG. 5 because measurements have not been performed before RLF, but still the target cell is known to the WTRUUE. In this example, like the others, the measurement and RLF/re-establishment is based on both the current cell stop time and the next cell start time. RLF may be triggered directly without T310, but in this example the cell 2 start time is the main factor triggering the start of procedures except for skipping T310 and stopping RLM on the cell 1, which is based on cell 1 stop time.

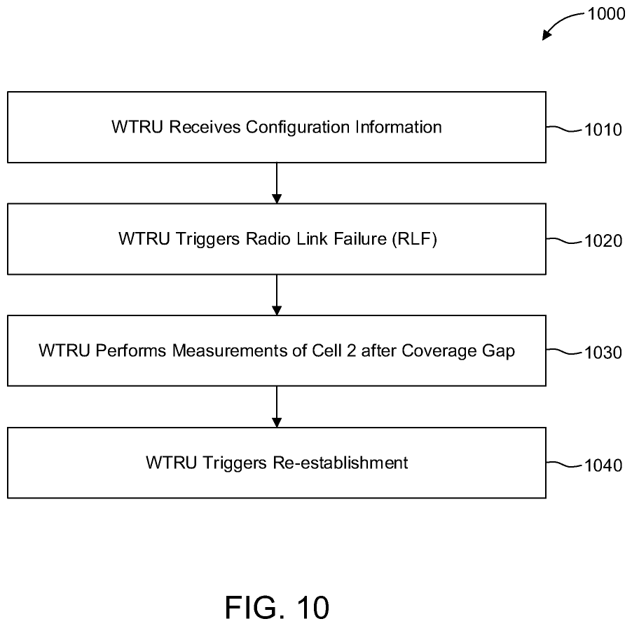

FIG. 10 shows an example method 1000 of RLF enhancement for a discontinuous coverage scenario.

FIG. 10 shows an example method 1000 of RLF enhancement for a discontinuous coverage scenario. The WTRU may be in current coverage of a first cell (e.g. cell 1) and may move into coverage of a second cell (e.g. cell 2). There may be a period of time (coverage gap) between cell 1 stopping and cell 2 starting.

The WTRU may receive configuration information 1010. The configuration information may indicate time information indicating when cell 1 stops and when cell 2 starts. The configuration information may indicate one or more radio quality thresholds, for example an RSRP threshold and an RSRP delta threshold. The configuration information may be received in one message or a plurality of messages. The WTRU may determine the coverage gap based on the cell 1 stop time and the cell 2 start time. The configuration information may be provided, for example, in system information or may be provided in RRC dedicated signaling. The configuration information may include location information of the current and neighboring satellites which the WTRU may use to estimate the current cell stop time and next cell start time, rather than an explicit time indication.

The WTRU may trigger or declare RLF 1020. The WTRU may trigger or declare RLF at the time when cell 1 stops. The WTRU may trigger or declare RLF based on detection of a single, or reduced number of out-of-sync indications after the time when cell 1 stops.

The WTRU may perform measurements on cell 2 1030. The measurements may be triggered after RLF. The measurements may be triggered after the duration of the coverage gap. The measurements may be triggered when cell 2 becomes available (i.e. at the cell 2 start time). The WTRU may start a T311 timer when cell 2 becomes available (i.e. at cell 2 start time).

The WTRU may trigger and/or perform a re-establishment procedure 1040. Similar to the example in FIG. 7, the T311 may be shorter than that used for regular RLF re-establishment, but longer than the value that may be used in the example in FIG. 5 because measurements have not been performed before RLF, but still the target cell is known to the WTRU. In this example, the measurement and RLF/re-establishment is based on both the current cell stop time and the next cell start time.

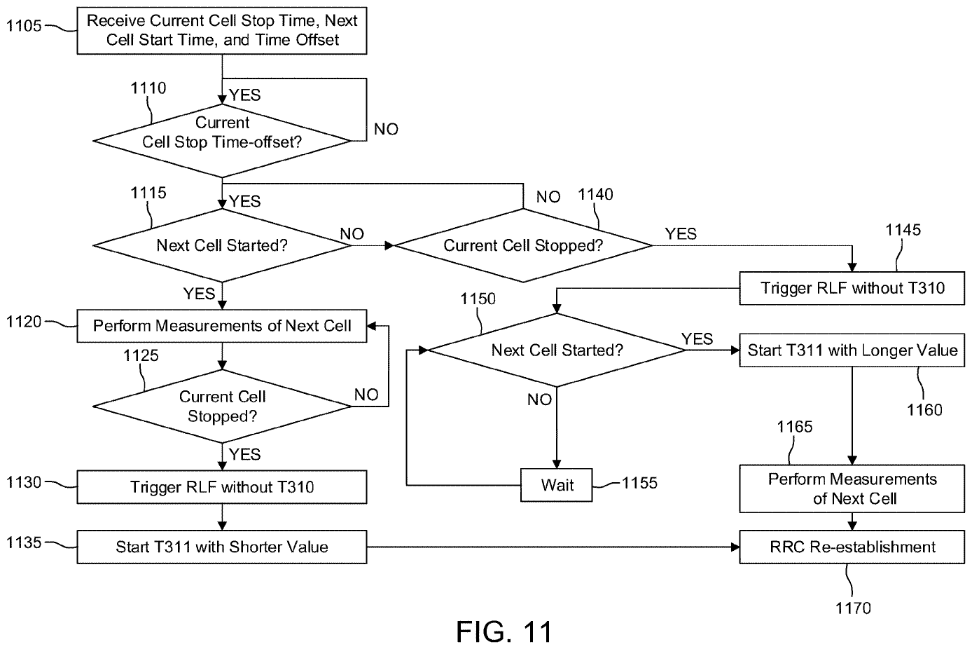

FIG. 11 shows and example flowchart for an enhanced RLF/re-establishment procedure.

A WTRU may receive configuration information 1105. The configuration information may indicate a current cell/serving cell (e.g. cell 1) stop time, a next cell/incoming cell (e.g. cell 2) start time, and a time offset value (e.g. X seconds) regarding cell 1 stop time. The time offset value may be used to determine when to start measurements if it is before cell 1 stops. The configuration information may be provided, for example, in system information or may be provided in RRC dedicated signaling. The configuration information may include other criteria such as RSRP thresholds for determining when to start measurements or for determining the length of a coverage gap. The configuration information may include location information of the current and neighboring satellites which the WTRU may use to estimate the current cell stop time and next cell start time, rather than an explicit time indication.

The WTRU may determine whether the time until the current cell stops is within the received time offset value 1105. If not, the WTRU may continue radio link monitoring until the time until the current cell stop is within the received time offset value.

If the time until the current cell stops is within the received time offset value, the WTRU may determine whether the next cell has started 1115. If the next cell has not started the WTRU may determine if the current cell has stopped 1140.

If the next cell start time has elapsed and the next cell has started, the WTRU may perform measurements on the next cell 1120. The measurements may be used to detect and determine a cell quality level.

The WTRU may determine if the current cell has stopped 1125. Until the current cell stops the WTRU may perform measurements of the next cell.

When the current cell stops the WTRU may trigger RLF and stop RLM on the current cell 1130. The WTRU may trigger RLF and stop RLM on the current cell without using timer T310 to attempt to recover the radio link on the current cell.

The WTRU may start a timer T311 with a shorter (e.g. shortest) value 1135. The WTRU may perform a RRC re-establishment procedure 1170.

If the WTRU determines that the next cell has not started, the WTRU may determine if the current cell has stopped 1140. If the current cell has stopped, the WTRU may trigger RLF, without using timer T3101145. If the current cell has not stopped the WTRU determines whether the next cell has started 1115.

If the current cell has stopped and the next cell did not start before this time, the WTRU may trigger RLF and may stop RLM on the current cell without using timer T310 to attempt to recover the radio link on the current cell 1145.

The WTRU may determine if the next cell has started 1150. If the next cell has not started, the WTRU may wait 1155 and make another determination if the next cell has started 1150. The wait time may be the duration of a coverage gap (e.g. in a discontinuous scenario). If the next cell has started, the WTRU may start a timer T311 with a longer value 1160. This longer value may be longer with respect to the T311 value from 1135.

The WTRU may start measurements on the next cell 1165.

The WTRU may perform a RRC re-establishment procedure 1170.

In the example of FIG. 11, the WTRU may determine both the current cell stop time and the next cell start time to determine when to start measurements of the next cell, when to trigger RLF (and stop RLM on the current cell), and when to execute re-establishment on the next cell.

The new T311 value may be explicitly signaled or it may be determined by applying an offset or it may be scaled depending on when the measurements are performed (i.e. before or after RLF). The new T311 value may be shorter if measurements have already been performed. The new T311 value may be used (e.g. only used) for attempting to re-establish on the indicated next NTN cell. Upon the new T311 expiration, the WTRU may fall back to a legacy RLF procedure. That is, the WTRU may perform a cell search, for other cells, and use the legacy T311 timer, which upon expiration triggers an RRC connection failure.

The WTRU may report whether re-establishment was triggered due to a real RLF or due to a time based trigger. This may be indicated using a new RRC re-establishment cause. This may be indicated using a new explicit indication in an uplink message. This may be logged and reported to the network at a later time, for example as part of an RLF report used for MDT/SON. The WTRU may report whether a fall back has occurred (i.e. whether the new T311 was first applied due to the previous cell stop time passing but then the WTRU failed to re-establish to the new cell within the (new) T311). This may occur if the WTRU does re-establish to any new cell, including the original cell or the failure cell, within the legacy T311 timer.

Some randomization may be applied to re-establishment time to avoid many WTRUs initiating random access to perform re-establishment at the same time due to the previous cell stopping at the same time for many WTRUs, and/or the new cell starting at the same time for many WTRUs. The WTRU may generate a re-establishment time based on the next cell start time and a semi-random value. The semi-random value may be based on a WTRU-ID. The semi-random value may include selecting any value in a range of, for example, 0-100 percent, comparing to a threshold and selecting one time if the random value is below a threshold and another time if the random value is above the threshold.

In an example where the WTRU triggers a re-establishment after cell 2 appears but before cell 1 stops, the WTRU may apply randomisation to the re-establishment trigger time. This spreads the re-establishment attempts from multiple WTRUs over time to minimise RACH and/or CN signalling congestion. The WTRU may, for example, calculate a random time within the time window starting at the point that cell 2 starts, and ending at the point that cell 1 stops (i.e. during the time at which it is known that coverage is provided by both cell 1 and cell 2).

The WTRU may determine or calculate a time range based on the stop time of cell 1 and the start time of cell 2 and may choose a semi-random value from within a uniform distribution range calculated from within this range.

The WTRU may calculate a time range based upon the time at which cell 2 is detected and measured, and the expected stop time of cell 1.

The WTRU may take into account the service, bearer, or traffic characteristics when determining the time to trigger RLF/re-establishment. For example, if the WTRU has an ongoing data exchange (e.g. transmission or reception) then the WTRU may delay declaring RLF until the time at which the data exchange has ended, or until the time at which cell 1 stops. The WTRU may use a data inactivity timer to determine when the data exchange stops, for example a DRX inactivity timer. If the WTRU has a delay tolerant service configured, the WTRU may trigger the re-establishment earlier, for example as soon as cell 2 starts. If the WTRU has a service which is delay sensitive then the re-establishment may be delayed in order to take advantage of the cell 1 availability for as long as possible.

In some examples, the WTRU may additionally take into account TN network measurements. For example, if the current cell is within X seconds before the stop time, but the next NTN cell is not yet available, the WTRU may trigger measurements on the TN to try and find a suitable cell that could be selected more quickly, or if the NTN re-establishment fails. In some examples, the TN measurements may be triggered only if a coverage gap is expected. In some examples, the WTRU may perform TN measurements once the RLF has been triggered. In some examples the TN measurements may be performed only if the NTN cell has not been successfully selected within the (new) T311 time.

In some examples, more than one target NTN cell may be provided to the WTRU. In this case the WTRU may take into account the start time of all of these target cells, and perform measurements on those cells according to their respective start time. T311 may be adjusted if more than one cell is provided as a target.

The WTRU may use a distance or location based criteria instead of or in addition to start and stop times of the current and neighbour cells. In an example, in addition to or alternatively to a stop time of cell 1, the WTRU may use a criteria comparing the WTRU measured location (e.g. using GNSS) against a reference point configured by the network. The reference point may, for example, indicate a position within cell 1. In an example, in addition to or alternatively to a start time of cell 2, the WTRU may use a criteria comparing the WTRU measured location (e.g. using GNSS) against a reference point configured by the network. The reference point may, for example, indicate a position within cell 2.

The WTRU may monitor one or more distances, and may perform an action, for example, if the distance meets/exceeds/falls below a distance threshold criteria. The distance threshold may be, for example, based on one or more of the following: the WTRU-satellite distance; the distance between the WTRU-satellite cell center; the distance between the WTRU and satellite footprint; the distance between the WTRU and a terrestrial-based gNB; the distance between the WTRU and the edge of terrestrial coverage; and the distance between a WTRU and a reference point.

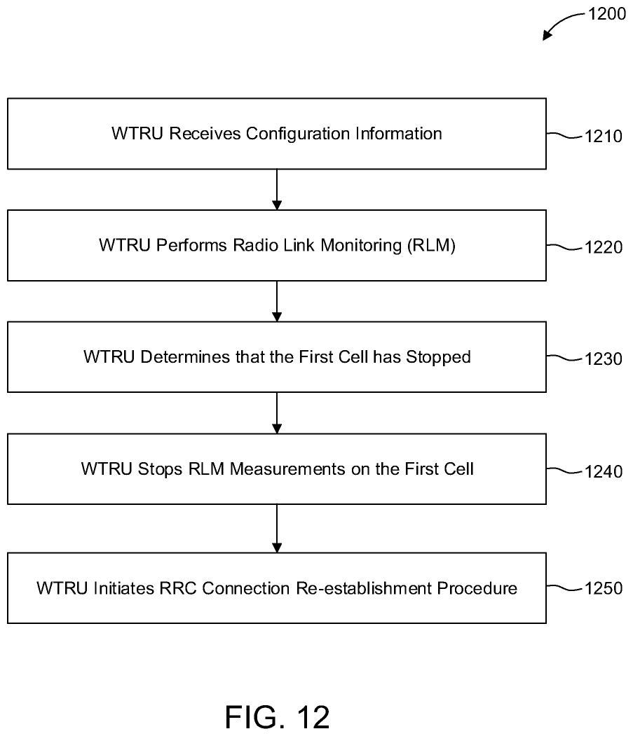

FIG. 12 shows an example method of enhanced RLF/re-establishment 1200. The WTRU may receive configuration information 1210. The configuration information may indicate time information indicating a stop time of a first cell and a start time of a second cell. The first cell may be a current cell where the WTRU is in coverage. The second cell may be a neighbor cell (target cell). The configuration information may indicate a time offset value (e.g. X seconds) relating to the stop time of the first cell. The configuration information may indicate one or more radio quality thresholds, for example an RSRP threshold and an RSRP delta threshold. The configuration information may be received in one message or a plurality of messages. The configuration information may be provided, for example, in system information or may be provided in RRC dedicated signaling. The configuration information may include location information of the current and neighboring satellites which the WTRU may use to estimate the current cell stop time and next cell start time, rather than an explicit time indication.

The WTRU may perform radio link monitoring (RLM) of the first cell 1220. The WTRU may determine that the first cell has stopped (1230). The determination that the first cell has stopped may be based on the received information indicating a stop time of the first cell. The WTRU may stop the RLM measurements on the current cell 1240. The WTRU may initiate a radio resource control (RRC) connection re-establishment procedure on the second cell in response to the determination that the first cell has stopped 1250.

The WTRU may perform measurements on the second cell. The measurements on the second cell may be before the first cells stops and on a condition that the second cell has started. The measurements may be performed on the second cell when the current cell stop time is within a received time offset value of stopping. The WTRU may delay initiating the connection re-establishment procedure on the second cell on a condition that the first cell stops before the second cell starts and until the second cell starts. The measurements may be performed on the second cell before an occurrence of a radio link failure (RLF). The measurements may be performed on the second cell upon an occurrence of a RLF. The WTRU may perform RRC connection re-establishment based on the stop time of the first cell and the start time of the second cell. RRC connection re-establishment may be performed without using a T310 timer expiration. The WTRU may trigger a RLF or an RRC connection re-establishment on a condition that a cell quality level criteria is met. The cell quality level criteria may comprise a measured signal quality of the second cell is above an RSRP or RSRQ threshold. The cell quality level criteria may comprise a measured signal quality of the first cell is below an RSRP or RSRQ threshold.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving configuration information, wherein the configuration information comprises an indication of a stop time of a first cell and a start time of a second cell;
performing radio link monitoring (RLM) measurements on the first cell;
determining that radio link failure (RLF) has occurred based on the first cell stopping based on the received indication of the stop time of the first cell;
and
initiating a radio resource control (RRC) connection re-establishment procedure in response to the determination that RLF has occurred based on the first cell stopping.

2. The method of claim 1, wherein the first cell is a current cell and the second cell is a neighbor cell or a target cell.

3. The method of claim 1, wherein the configuration information further comprises a time offset value, wherein the time offset value is related to the stop time of the first cell.

4. The method of claim 3, further comprising:
performing measurements on the second cell, wherein the measurements are performed on the second cell when the first cell stop time is within the time offset value of stopping.

5. The method of claim 1, further comprising:
performing measurements on the second cell before the first cells stops and on a condition that the second cell has started.

6. The method of claim 5, wherein the measurements are performed on the second cell before an occurrence of a RLF or upon an occurrence of a RLF.

7. The method of claim 1, further comprising:
delaying initiating the RRC connection re-establishment procedure based on the first cell stopping before the second cell starts and until the second cell starts.

8. The method of claim 1, further comprising:
initiating the RRC connection re-establishment procedure based on the stop time of the first cell and the start time of the second cell.

9. The method of claim 1, wherein the RRC connection re-establishment procedure is performed without using a T310 timer expiration.

10. The method of claim 1, further comprising:
triggering a RLE or an RRC connection re-establishment on a condition that a cell quality level criteria is met, wherein the cell quality level criteria comprises at least one of: a measured signal quality of the second cell is above a reference signal received power (RSRP) or a reference signal received quality (RSRQ) threshold and a measured signal quality of the first cell is below an RSRP or RSRQ threshold.

11. A wireless transmit/receive unit (WTRU) comprising:
a transceiver; and
a processor, wherein:
the transceiver is configured to receive configuration information, wherein the configuration information comprises an indication of a stop time of a first cell and a start time of a second cell;
the processor and the transceiver are configured to perform radio link monitoring (RLM) measurements on the first cell;
the processor is further configured to determine that radio link failure (RLF) has occurred based on the first cell stopping based on the received indication of the stop time of the first cell;
and
the processor is further configured to initiate a radio resource control (RRC) connection re-establishment procedure in response to the determination that RLF has occurred based on the first cell stopping.

12. The WTRU of claim 11, wherein the first cell is a current cell and the second cell is a neighbor cell or a target cell.

13. The WTRU of claim 11, wherein the configuration information further comprises a time offset value, wherein the time offset value is related to the stop time of the first cell.

14. The WTRU of claim 13, wherein the measurements are performed on the second cell when the first cell stop time is within the time offset value of stopping.

15. The WTRU of claim 11, wherein: the processor is further configured to perform measurements on the second cell before the first cell stops and on a condition that the second cell has started.

16. The WTRU of claim 15, wherein the measurements are performed on the second cell before an occurrence of a RLF or upon an occurrence of a RLF.

17. The WTRU of claim 11, wherein:
the processor is further configured to delay initiating the RRC connection re-establishment procedure on a condition that the first cell stops before the second cell starts and until the second cell starts.

18. The WTRU of claim 11, wherein:
the processor is further configured to initiate the RRC connection re-establishment procedure based on the stop time of the first cell and the start time of the second cell.

19. The WTRU of claim 11, wherein the RRC connection re-establishment procedure is performed without using a T310 timer expiration.

20. The WTRU of claim 11, wherein:
the processor is further configured to trigger RLF or an RRC connection re-establishment on a condition that a cell quality level criteria is met, wherein the cell quality level criteria comprises at least one of: a measured signal quality of the second cell is above a reference signal received power (RSRP) or a reference signal received quality (RSRQ) threshold and a measured signal quality of the first cell is below an RSRP or RSRQ threshold.
